(19) United States
(12) Patent Application Publication
(10) Pub. No.: US 2018/0059354 A1
(43) Pub. Date: Mar. 1, 2018

(54) MINIATURE ACTIVE ALIGNMENT LENS ASSEMBLY AND METHOD OF MANUFACTURING SAME

(71) Applicant: L1Optics, Arcadia, CA (US)

(72) Inventors: ROMAN GUTIERREZ, Arcadia, CA (US); JING XU, Arcadia, CA (US); Pat Leang, Arcadia, CA (US)

(73) Assignee: L1Optics, Arcadia, CA (US)

(21) Appl. No.: 15/680,191

(22) Filed: Aug. 17, 2017

Related U.S. Application Data
(60) Provisional application No. 62/381,267, filed on Aug. 30, 2016.

(51) Int. Cl. G02B 7/00; G02B 7/02

(52) U.S. Cl. CPC G02B 7/003; G02B 13/001; G02B 7/021

(57) ABSTRACT

Lens assemblies and methods of manufacture are disclosed utilizing localized melting. Features may be included on movable lenses, portions of the lens barrel, or a combination thereof, the features designed to interact with a flow of melted material caused by the localized melting. Once the melted material cools, the movable lenses and lens barrel are fused together, securing the movable lens in place. Localized melting may also be utilized for active alignment, strategically melting portions of the lens barrel, movable lens, or other structure to adjust the movable lens.

### RELATED APPLICATIONS

This application claims the benefit of U.S. Provisional Patent Application No. 62/381,267, filed Aug. 30, 2016, the content of which is incorporated herein by reference in its entirety.

### TECHNICAL FIELD

The disclosed technology relates generally to lens assemblies, and more particularly, some embodiments relate to an improved active alignment lens assembly.

### DESCRIPTION OF THE RELATED ART

Various portable electronic devices (e.g., cell phones, tablets, laptops, etc.) use miniature digital cameras to capture photographs and video. These miniature digital cameras include a miniature lens assembly, i.e., a lens assembly having a lens diameter of about 0.25 inches or less, which captures the light and focuses it onto a CMOS imager to capture an image. Inside a miniature projector, a lens assembly focuses the light from an LED array onto a screen or an object. The continuing demand for smaller and higher quality low cost imaging lens assemblies presents a considerable challenge to optical and mechanical design. The lenses in the assembly should be aligned with respect to each other or lens barrel within a few microns to ensure good image quality. Alignment errors between the lenses lead to a reduction in image quality. When the image quality of a lens assembly is not acceptable, the lens assembly is rejected. This leads to undesirable yield loss in the manufacturing of lens assemblies.

To reduce lens alignment errors and improve manufacturing yields of lens assemblies, a variety of passive alignment methods have been devised.

For example, referring to FIGS. 1A and 1B, reproduced from FIGS. 4 and 2, respectively, of U.S. Pat. No. 7,088,530 entitled “Passively Aligned Optical Elements” to Recco et al. In FIG. 1A, the alignment of two lenses L1 and L2 uses mating tapered surfaces 24 and 34. In FIG. 1B, lenses L1 and L3 are aligned to each other using the lens barrel 22. Lenses in this lens assembly are tightly stacked inside the lens barrel 22 into predefined positions and are not allowed to move.

As the resolution of a miniature camera increases, and the performance requirements for the lens assemblies become more stringent, the number of lenses in the lens assembly often increases. The increase in the number of optical elements that are stacked up tends to increase the impact of any alignment errors. As a result, the yield loss in the manufacture of lens assemblies using prior art passive alignment becomes worse when the number of lenses in the assembly increases.

As lens assemblies become smaller, the amount of light collected by the lens assembly is reduced and lower f-number designs are required. The larger aperture designs magnify the sensitivity to lens alignment errors and the yield loss in the manufacture of lens assemblies using prior art passive alignment becomes worse.

Active alignment of lenses is typically used for high performance optical systems where the cost of the active alignment is not an issue. However, known active alignment techniques, such as those that rely on the use of an autocollimator and a rotational stage to individually align lenses can be too complex and costly for high-volume production of miniature lens assemblies.

There is a need in the art for a low cost method of manufacturing lens assemblies for use in miniature cameras and miniature projectors that combines the performance advantages of active alignment and the low cost advantages of passive alignment.

Moreover, some active alignment lens assemblies utilize epoxy to secure the lenses in place once aligned. This can involve applying epoxy to one or more areas around a lens to secure the lens to a lens barrel and/or other lenses. The epoxy is cured for a period of time to avoid lens movement and possible lens misalignment. Not only does this result in added manufacturing time (waiting for the epoxy to cure and harden), but errors could occur when applying the epoxy. Thus, in some applications, there is a need in the art for an alternative mechanism for securing one or more lenses in an active alignment lens assembly.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1A is a perspective view of an example of a prior art lens assembly.

FIG. 1B is a cross-sectional view of the prior art lens assembly of FIG. 1A.

FIG. 2 is a cross-sectional view of an example lens assembly in accordance with embodiments of the technology disclosed herein.

FIG. 3 is a cross-sectional view of another example lens assembly in accordance with embodiments of the technology disclosed herein.

FIG. 4 is a cross-sectional view of another example lens assembly in accordance with embodiments of the technology disclosed herein.

FIG. 5 is a cross-sectional view of another example lens assembly in accordance with embodiments of the technology disclosed herein.

FIG. 6 is a cross-sectional view of another example lens assembly in accordance with embodiments of the technology disclosed herein.

FIG. 7 is a cross-sectional view of another example lens assembly in accordance with embodiments of the technology disclosed herein.

FIG. 8 is a cross-sectional view of another example lens assembly in accordance with embodiments of the technology disclosed herein.

FIG. 9 is a cross-sectional view of another example lens assembly in accordance with embodiments of the technology disclosed herein.

FIG. 10 is a front view of the example lens assembly of FIG. 9.

FIG. 11 is a flowchart for a method of making a lens assembly in accordance with embodiments of the technology disclosed herein.

FIG. 12 is a flowchart for another method of making a lens assembly in accordance with embodiments of the technology disclosed herein.

FIG. 13 illustrates a perspective view of an example lens assembly in accordance with embodiments of the technology disclosed herein.

FIG. 14A illustrates an example movable lens with features designed to take advantage of localized melting in accordance with embodiments of the technology disclosed herein.

FIG. 14B illustrates an example arrangement of a movable lens in a traditional lens assembly enabling active alignment.

FIG. 15 illustrates a modified version of the lens assembly discussed with respect to FIG. 2, in accordance with embodiments of the technology disclosed herein.

FIG. 16 is a flow chart of an example active alignment method in accordance with embodiments of the technology discussed herein.

FIG. 17 is a flowchart for another example active alignment method in accordance with embodiments of the technology disclosed herein.

FIG. 18 illustrates an example computing module that may be used in implementing various features of embodiments of the disclosed technology.

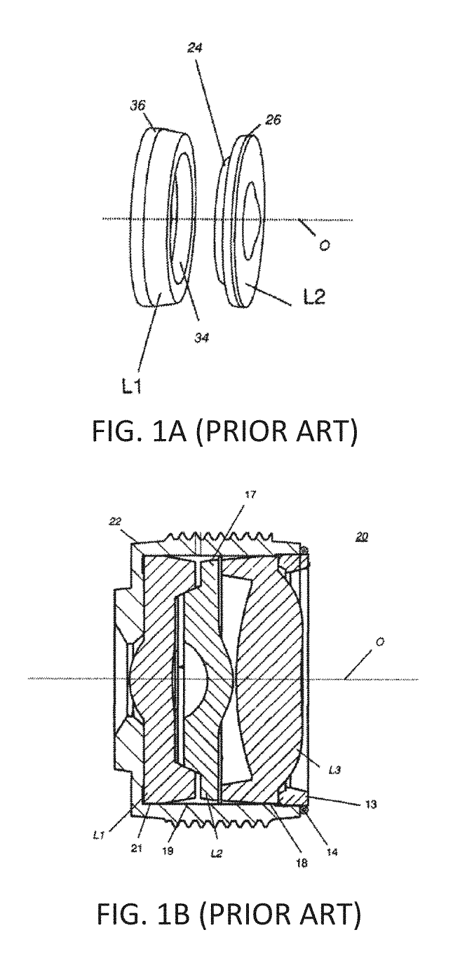

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

Embodiments of the technology disclosed herein are directed toward an improved active alignment lens assembly for use in optical devices, such as digital cameras. More particularly, the various embodiments of the technology disclosed herein relate to an improved design for a movable lens for use within an active alignment lens assembly. Features of the movable lens are designed to interface with the lens barrel of the lens assembly. Using a heat source, one or more portions of the lens barrel encompassing the movable lens and/or the movable lens itself is melted such that the melted material of the lens barrel and/or movable lens flows into or around features of the lens barrel/movable lens. Once the melted material cools, the movable lens is secured in place. In some embodiments, the features of the movable lens enables active alignment to occur without the need for mechanical grippers, instead utilizing the heat source to melt portions of the lens barrel strategically to move the lens through the interaction of the melted material and the targeted movable lens feature. In some embodiments, the heat source may be used to melt a non-optical imaging part of the movable lens.

In accordance with embodiments further described herein, various lens assemblies are provided which may be used in miniature cameras or miniature projectors included in, for example, portable electronic devices such as cellphones.

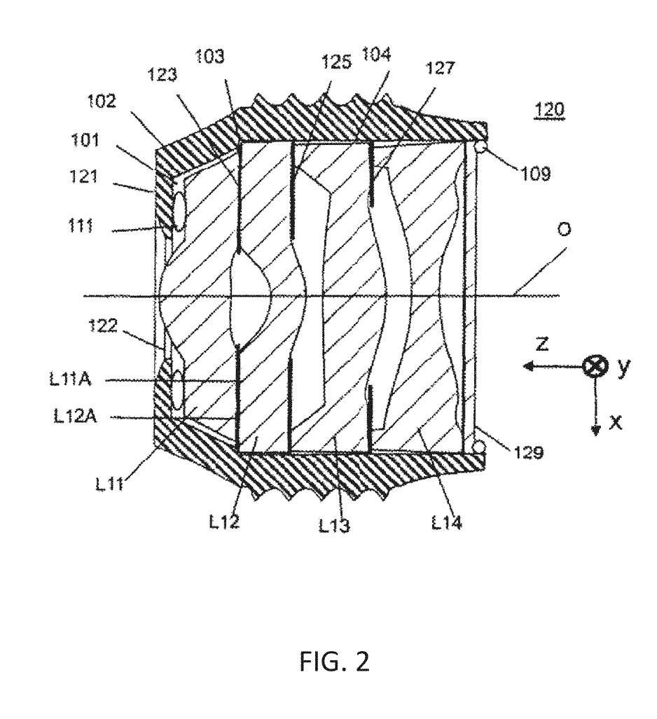

Referring now to the drawings, which are included for the purposes of illustrating embodiments of the technology disclosed herein, and not for limiting the same, FIG. 2 shows a cross-sectional view of a lens assembly in accordance with various embodiments of the technology of the present disclosure. The lens assembly 120 is comprised of four lenses L11, L12, L13, and L14; three baffles 123, 125 and 127; and an IRCF (infra-red cut filter) 129 inserted in a lens barrel 121. The baffles are interspersed between the lenses as shown. Lenses L11, L12, L13, and L14 are made of conventional lens material such as glass, plastic, optical crystal, or the like. Baffles 123, 125, and 127 are made of conventional baffle material such as plastic, cloth, paper, or the like. Lens barrel 121 is made of conventional lens barrel material such as plastic, metal, or the like. IRCF 129 is made of glass with an IR coating, plastic or other conventional material.

IRCF 129 filters out infra-red light while passing visible light in order to improve the color of the image captured by a CMOS image sensor (not shown). IRCF 129 is an optional part of the lens barrel assembly and both its presence and location depend on the camera design. Alternatively, IRCF 129 may be replaced with another conventional filter.

The front of the lens barrel contains an aperture 122 on the front side, which serves as the entrance pupil for the imaging system.

Lens L12 is positioned inside lens barrel 121 in contact with an inner edge 103 and inside surface 104 of lens barrel 121. Lens L13 is adjacent to, and separated by baffle 125 from, lens L12 and is also in contact with inside surface 104. Lens L14 is adjacent to, and separated by baffle 127 from, lens L13 and is also in contact with inside surface 104. IRCF 129 is positioned in contact with lens L14 and inside surface 104. The stack of optical elements is fixed inside the lens barrel by epoxy 109 that connects IRCF 129 with lens barrel 121.

As a result, lenses L12, L13, and L14 are passively aligned in the lens assembly through physical contact among the lenses L12, L13, and L14, the baffles, and lens barrel 121. Alternatively, lenses L12, L13, and L14 could be aligned merely by connections between them. Depending on the method used and the dimensional tolerance of the lenses and lens barrel, the resulting optical alignment precision between lenses may be between less than 1 micron to over 15 microns in the x, y, and z directions.

Movable lens L11 is positioned generally between aperture 122 and lens L12. Baffle 123 separates lenses L11 and L12. Movable lens L11 is not precisely positioned by the lens barrel 121 and there is a gap 101 that allows lens L11 to be moved in the z direction and a radial gap 102 that allows it to be moved in the x and y directions. The gap 102 allows between 5 microns and 50 microns of movement by lens L11 in the x and y directions, and preferably between 5 and 25 microns. Gap 101 may optionally be omitted.

To reduce certain optical aberrations such as astigmatism, the movable lens L11 may be aligned in the x and y directions so that its optical axis substantially coincides with the optical axis O of the lens assembly 120. This may be done by monitoring the through focus MTF (modulation transfer function) of the lens assembly while the position of the movable lens L11 is adjusted. The MTF measurement is known in the art and is typically performed by shining light through a mask that is placed at the image plane of the lens and monitoring the sharpness of the projected image with cameras. Through focus MTF measurement is also known in the art and consists of making multiple MTF measurements while changing the spacing between the lens assembly and the mask. Other conventional optical measurements of the lens assembly may be used for guiding the adjustment of the position of movable lens L11, including but not limited to, point spread function, line spread function, sharpness, contrast, brightness, spatial frequency response (SFR), subjective quality factor (SQF), and wave front measurements.

Misalignment of lenses L12, L13, and L14 and imperfections in the lenses themselves will typically cause the optical axis O of the lens assembly to not coincide exactly with the optical axis of lens L12. An idealized optical axis O of the lens assembly is shown in FIG. 2. Adjusting the alignment of lens L11 may be used to compensate, in whole or part, for such misalignment and imperfections or, alternatively, create desired optical effects.

Alternatively, since movement of lens L11 in the x and y directions also affects image plane tilt, the position of lens L11 may be adjusted so as to align the optical axis O with the perpendicular of the imager (not shown) so that the entire image is in better focus. This may be done during manufacturing of the lens assembly or after the lens assembly is mounted in the camera.

Once the movable lens L11 is aligned in the desired position, epoxy 111 is used to fix it in position. In some embodiments, epoxy can be replaced by material that is melted by a laser, hot air gun, or other local heating device. In some embodiments, epoxy can be replaced by local melting of the lens barrel 121 so that the melted material comes into contact with L11. As shown in FIG. 2, in various embodiments lens L11 has a flat surface L11A and lens L12 has a flat surface L12A, and both surfaces L11A and L12A are in contact with baffle 123. In an alternate embodiment, baffles 123, 125, and 127 are omitted allowing the lenses to contact each other directly at one or more interfaces. The baffles and interfaces between lenses are preferably designed to avoid allowing stray light to reach the imager (not shown).

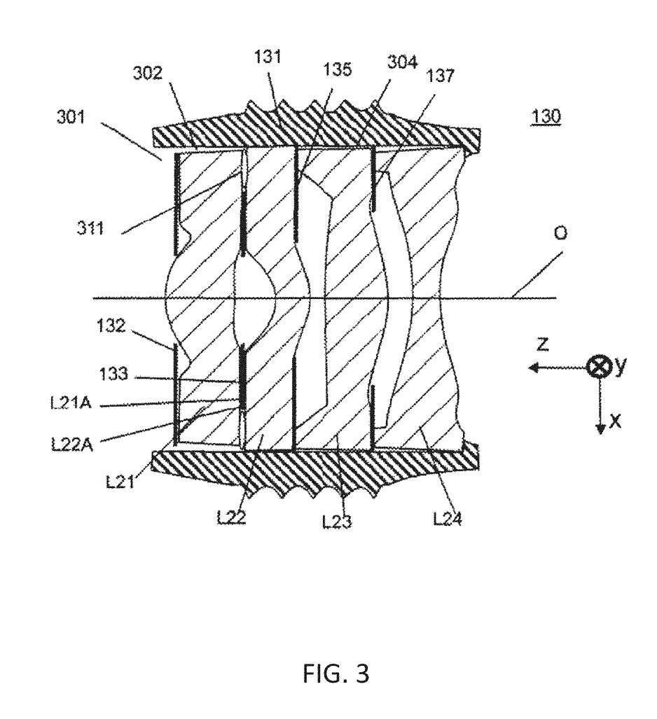

FIG. 3 shows a cross-sectional view of a lens assembly 130 in accordance with various embodiments of the technology disclosed herein. The lens assembly 130 is comprised of four lenses L21, L22, L23, and L24, and four baffles 132, 133, 135, and 137 inserted in a lens barrel 131. The baffles are interspersed between the lenses as shown. Lenses L21, L22, L23, and L24 are mode of conventional lens material such as glass, plastic, optical crystal, or the like. Baffles 132, 133, 135, and 137 are made of conventional baffle material such as plastic, cloth, paper, or the like. Lens barrel 131 is made of conventional lens barrel material such as plastic, metal, or the like.

Lens L24 is positioned inside the lens barrel 131 in contact with a back edge and inside surface 304 of lens barrel 131. Lens L23 is adjacent to, and separated by baffle 137 from, lens L24 and is also in contact with inside surface 304. Lens L22 is adjacent to, and separated by baffle 135 from, lens L23 and is also in contact with inside surface 304.

As a result, lenses L22, L23, and L24 are passively aligned in the lens assembly through physical contact among the lenses L22, L23, and L24, the baffles, and lens barrel 131. Alternatively, lenses L22, L23, and L24 could be aligned merely by connections between them. Depending on the method used and the dimensional tolerance of the lenses and lens barrel, the resulting optical alignment precision between lenses may be between less than 1 micron to over 15 microns in the x, y, and z directions.

Movable lens L21 is positioned in front of lens L22. Baffle 133 separates lenses L21 and L22. Movable lens L21 is not precisely positioned by lens barrel 131. Baffle 133 is positioned in contact with inside surface 304 of lens barrel 131 or by mating with a feature on the front surface of lens L22 or on the back surface of lens L21. Front baffle 132 on the front side of lens L21 serves as the entrance pupil for the imaging system and may be attached to lens L21 using, for example, adhesive. There is a space 301 that allows lens L21 to be moved in the z direction and a radial gap 302 that allows it to be moved in the x and y directions. Gap 302 allows movement of lens L21 in the x and y directions by between 5 microns and 50 microns, and preferable, between 5 and 25 microns.

To reduce certain optical aberrations such as astigmatism, the lens L21 may be aligned in the x and y directions so that its optical axis substantially coincides with the optical axis O of the lens assembly 130. This may be done by monitoring the through focus MTF of the lens assembly while the position of lens L21 is adjusted. Misalignment of lenses L22, L23, and L24 and imperfections in the lenses themselves will typically cause the optical axis O of the lens assembly to not coincide exactly with the optical axis of lens L22. An idealized optical axis O of the lens assembly is shown in FIG. 3. Adjusting the alignment of lens L21 may be used to compensate, in whole or part, for such misalignment and imperfections or, alternatively, create desired optical effects.

Alternatively, since movement of lens L21 in the x and y directions also affects image plane tilt, the position of lens L21 may be adjusted so as to align the optical axis O with the perpendicular of the imager (not shown) so that the entire image is in better focus. This may be done during manufacturing of the lens assembly or after the lens assembly is mounted in the camera.

Once lens L21 is aligned to the desired position, epoxy 311 is used to fix it in position with respect to lens L22. In an alternate embodiment, epoxy 311 may come in contact with lens barrel 131 and fix all lenses inside the lens barrel. In some embodiments, epoxy 311 can be replaced by material that is melted by a laser, hot air gun, or other local heating device. In some embodiments, epoxy 311 can be replaced by local melting of the lens barrel 131 so that the melted material comes into contact with L21. As shown in FIG. 3, in various embodiments lens L21 has a flat surface L21A and lens L22 has a flat surface L22A, and both surfaces L21A and L22A are in contact with baffle 133. In an alternate embodiment, baffles 133, 135, and 137 are omitted allowing the lenses to contact each other directly at one or more interfaces. The baffles and interfaces between lenses are preferably designed to avoid allowing stray light to reach the imager (not shown).

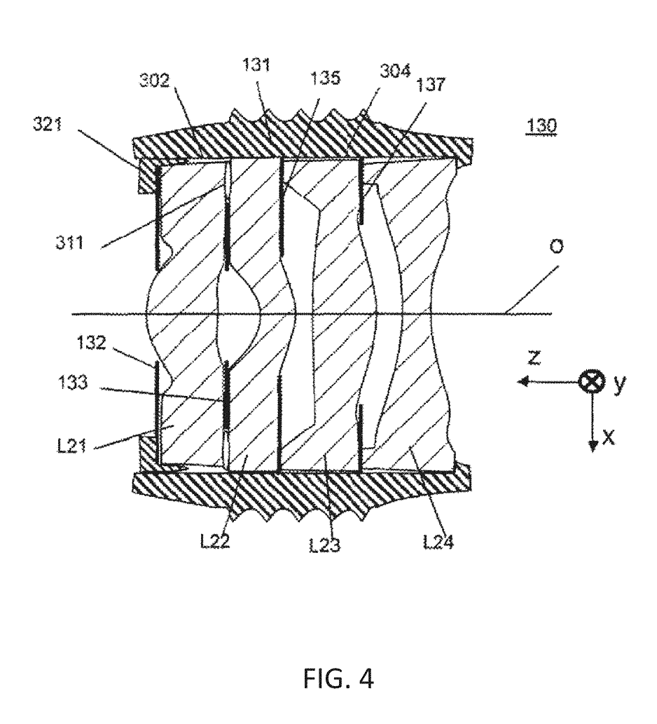

FIG. 4 shows a cross-sectional view of the lens assembly 130 of FIG. 3 with a passive alignment ring 321 added to fill a portion of gap 302. Passive alignment ring 321 is preferably made of rubber, plastic, epoxy, metal, or other conventional material. Passive alignment ring 321 can be used to passively align movable lens L21 into a position where the optical performance of the lens assembly is of sufficient quality to permit MTF measurements for determining whether more precise alignment of movable lens L21 is warranted. Passive alignment ring 321 is preferably removed after initial MTF measurements are made and before active alignment of movable lens L21. Ring 321 is preferably omitted from a final lens assembly, as shown in FIG. 3.

Alternatively, if the MTF measurements show that the lens assembly meets final requirements, passive alignment ring 321 may be left in place and remain present in the final lens assembly. As a result, some lens assemblies may have a passive alignment ring as illustrated in FIG. 4 and some may not as illustrated in FIG. 3. If the passive alignment ring 321 is left on the lens assembly 130, it may be preferably fixed to the lens barrel 131 using epoxy, welding, or another conventional method of attachment.

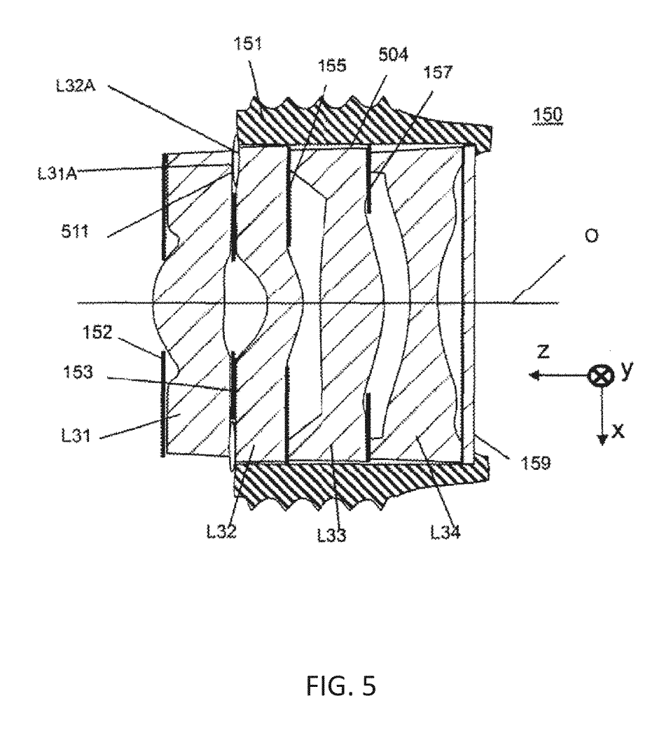

FIG. 5 shows a cross-sectional view of a lens assembly 150 in accordance with various embodiments of the technology disclosed herein. The lens assembly 150 is comprised of four lenses L31, L32, L33, and L34, an IRCF window 159, and four baffles 152, 153, 155, and 157 inserted in a lens barrel 151. The baffles are interspersed between the lenses as shown. Lenses L31, L32, L33, and L34 are made of conventional lens material such as glass, plastic, optical crystal, or the like. Baffles 152, 153, 155, and 157 are made of conventional baffle material such as plastic, cloth, paper, or the like. Lens barrel 151 is made of conventional lens barrel material such as plastic, metal, or the like. IRCF window 159 is made of glass with an IR coating, plastic, or other conventional material.

IRCF window 159 filters out infra-red light while passing visible light in order to improve the color of the image captured by a CMOS image sensor (not shown). IRCF window 159 is an optional part of the lens barrel assembly and both its presence and location depend on the camera design. Alternatively, IRCF window 159 may be replaced with another conventional filter.

IRCF window 159 is positioned inside lens barrel 131 in contact with a back edge and inside surface 504 of lens barrel 131. Lens L34 is in contact with IRCF window 159 and inside surface 504. Lens L33 is adjacent to, and separated by baffle 157 from, lens L34 and is also in contact with inside surface 504. Lens L32 is adjacent to, and separated by baffle 155 from, lens L33 and is also in contact with inside surface 504.

As a result, lenses L32, L33, and L34 are passively aligned in the lens assembly through physical contact among the lenses L32, L33, and L34, the baffles, and lens barrel 151. Alternatively, lenses L32, L33, and L34 could be aligned merely by connections between them. Depending on the method used and the dimensional tolerance of the lenses and lens barrel, the resulting optical alignment precision between lenses may be between less than 1 micron to over 15 microns in the x, y, and z directions.

Movable lens L31 is positioned in front of lens L32. Baffle 153 separates lenses L31 and L32. Movable lens L31 is not positioned within lens barrel 151. Baffle 153 is adhered to, or mates with a feature on, the front surface of lens L32 or the back surfaces of lens L31. Front baffle 152 on the front side of lens L31 serves as the entrance pupil for the imaging system and may be attached to lens L31 using, for example, adhesive. The movable lens L31 lies substantially outside the lens barrel 151 and is free to move in the x, y, and z directions.

To reduce certain optical aberrations such as astigmatism, lens L31 may be aligned in the x and y directions so that its optical axis substantially coincides with the optical axis O of the lens assembly 150. This may be done by monitoring the through focus MTF of the lens assembly while the position of lens L31 is adjusted. Misalignment of lenses L32, L33, and L34 and imperfections in the lenses themselves will typically cause the optical axis O of the lens assembly to not coincide exactly with the optical axis of lens L32. An idealized optical axis O of the lens assembly is shown in FIG. 5. Adjusting the alignment of lens L31 may be used to compensate, in whole or part, for such misalignment and imperfections or, alternatively, create desired optical effects.

Alternatively, since movement of lens L31 in the x and y directions also affects image plane tilt, the position of lens L31 may be adjusted so as to align the optical axis O with the perpendicular of the imager (not shown) so that the entire image is in better focus. This may be done during manufacturing of the lens assembly or after the lens assembly is mounted in the camera.

Once lens L31 is aligned to the desired position, epoxy 511 is used to fix it in position with respect to lens L32 and lens barrel 151 and fix all lenses inside the lens barrel. In some embodiments, epoxy 511 can be replaced by material that is melted by a laser, hot air gun, or other local heating device. In some embodiments, epoxy 511 can be replaced by local melting of the lens barrel 151 so that the melted material comes into contact with L21. As shown in FIG. 5, in various embodiments lens L31 has a flat surface L31A and lens L32 has a flat surface L32A, and both surfaces L31A and L32A are in contact with baffle 153. In an alternate embodiment, baffles 153, 155, and 157 are omitted allowing the lenses to contact each other directly at one or more interfaces. The baffles and interfaces between lenses are preferably designed to avoid allowing stray light to reach the imager (not shown).

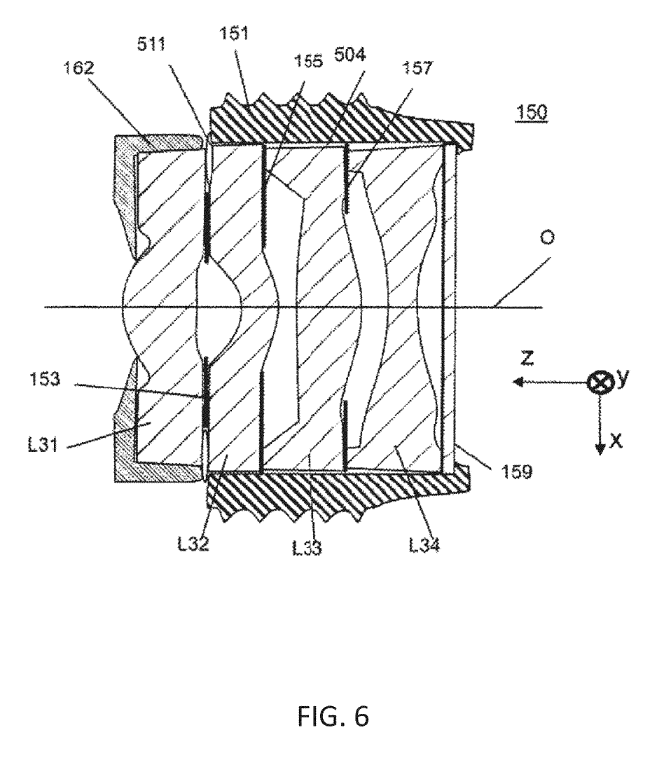

FIG. 6 shows a cross-sectional view of the lens assembly 150 in FIG. 5 with a lens cover 162 replacing the baffle 152. Cover 162 preferably prevents stray light from entering the optical system through the sides of lens L31. Like baffle 152, lens cover 162 may define an entrance pupil for the imaging system. Cover 162 may be made of injection molded plastic and attached to lens L31 by interference fit, with adhesive, or like attachment. In some embodiments, epoxy 511 can be replaced by local melting of the lens cover 162 and or the lens barrel 131 so that the melted material mechanically joins the lens cover 162 and the lens barrel 131.

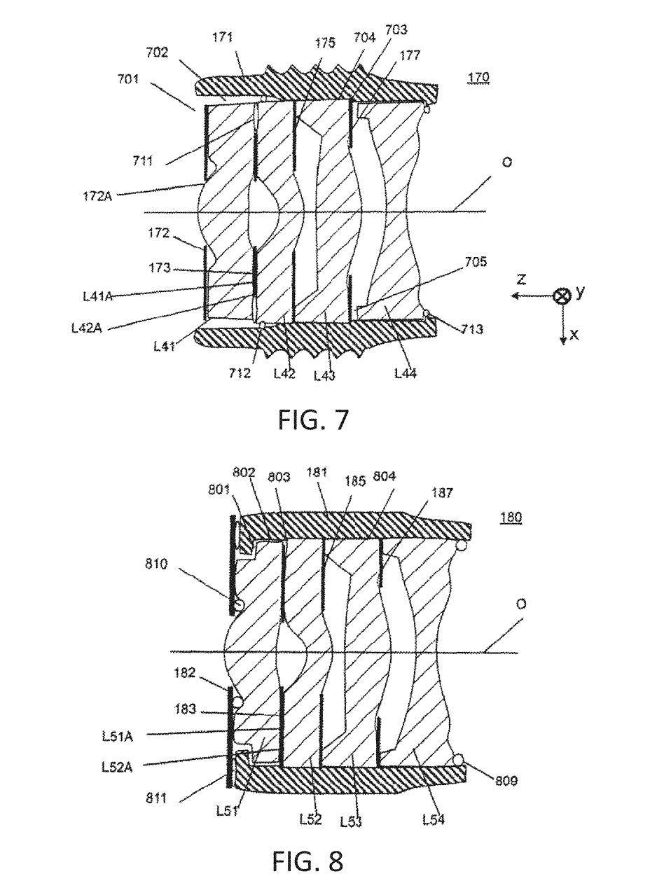

FIG. 7 shows a cross-sectional view of a lens assembly 170 in accordance with various embodiments of the technology disclosed herein. The lens assembly 170 is comprised of four lenses L41, L42, L43, and L44, and four baffles 172, 173, 175, and 177. The positions of the first movable lens L41 and the second movable lens L44 are adjustable in order to optimize the optical performance of the lens assembly 170. The second lens L42 and the third lens L43 are passively aligned. The baffles are interspersed between the lenses as shown in FIG. 7. Lenses L41, L42, L43, and L44 are made of conventional lens material such as glass, plastic, optical crystal, or the like. Baffles 172, 173, 175, and 177 are made of conventional baffle material such as plastic, cloth, paper, or the like. Lens barrel 171 is made of conventional lens barrel material such as plastic, metal, or the like.

Baffle 177 is positioned inside lens barrel 171 in contact with edge 703 and inside surface 704 of lens barrel 171. Lens L43 is positioned inside lens barrel 171 in contact with baffle 177 and inside surface 704 of lens barrel 171. Lens L42 is adjacent to, and separated by baffle 175 from, lens L43 and is also in contact with inside surface 704. Optionally, epoxy 712 attaches lens L42 to inside surface 704 and fix the position of lenses L42 and L43.

As a result, lenses L42 and L43 are passively aligned in the lens assembly through physical contact among the lenses L42 and L43, the baffles, and lens barrel 171. Alternatively, lenses L42 and L43 could be aligned merely by connections between them. Depending on the method used and the dimensional tolerance of the lenses and lens barrel, the resulting optical alignment precision between lenses L42 and L43 may be between less than 1 micron to over 15 microns in the x, y, and z directions.

Movable lens L41 is positioned in front of lens L42. Baffle 173 separates lenses L41 and L42. Movable lens L41 is positioned in lens barrel 171 but is not precisely positioned. Radial gap 702 allows movement of lens L41 in the x and y directions by between 5 microns and 50 microns, and preferably, between 5 and 25 microns. Baffle 173 is adhered to, mates with a feature on, or is aligned with a recessed feature on, the front surface of lens L42 or the back surface of lens L41.

The front baffle 172 is attached to the front surface of the movable lens L41 using, for example, adhesive. Baffle 172 has an aperture 172A that defines the entrance pupil for the imaging system. The entrance pupil may also be formed by baffle 173 or another aperture in the system. There is a space 701 that allows lens L41 to be moved in the z direction.

Movable lens L44 is positioned in lens barrel 171 behind lens L43 and baffle 177 but is not precisely positioned. Gap 705 separates baffle 177 and lens L44 and allows movable lens L44 to be moved in the z direction adjusting its spacing with respect to fixed lens L43. The position of lens L44 in the x and y directions and its tilt about the x and y axes is passively set by contact with the inside surface 704 of lens barrel 171.

In an alternate embodiment, there is a radial gap between lens L44 and lens barrel 171 to allow the position and tilt of lens L44 to be adjusted in the x and y directions.

To reduce certain optical aberrations such as astigmatism, lens L41 may be aligned in the x and y directions so that its optical axis substantially coincides with the optical axis O of the lens assembly 170. This may be done by monitoring the through focus MTF of the lens assembly while the position of lens L41 is adjusted. Misalignment of lenses L42, L43, and/or L44 and imperfections in the lenses themselves will typically cause the optical axis O of the lens assembly to not coincide exactly with the optical axis of lens L42. An idealized optical axis O of the lens assembly is shown in FIG. 7. Adjusting the alignment of lens L41 may be used to compensate, in whole or part, for such misalignment and imperfections or, alternatively, create desired optical effects.

Alternatively, since movement of lens L41 in the x and y directions also affects image plane tilt, the position of lens L41 may be adjusted so as to align the optical axis O with the perpendicular of the imager (not shown) so that the entire image is in better focus. This may be done during manufacturing of the lens assembly or after the lens assembly is mounted in the camera.

Once lens L41 is aligned in the desired position, epoxy 711 is used to fix it in position with respect to lens L42. In an alternate embodiments, epoxy 711 may come in contact with lens barrel 171 and fix lenses L41, L42, and L43 inside the lens barrel. In some embodiments, epoxy 711 can be replaced by material that is melted by a laser, hot air gun, or other local heating device. In some embodiments, epoxy 711 can be replaced by local melting of the lens barrel 171 so that the melted material comes into contact with L41. As shown in FIG. 7, in various embodiments lens L41 has a flat surface L41A and lens L42 has a flat surface L42A, and both surfaces L41A and L42A are in contact with baffle 173. In an alternate embodiment, baffles 173, 175, and 177 are omitted, allowing the lenses to contact each other directly at one or more interfaces. The baffles and interfaces between lenses are preferably designed to avoid allowing stray light to reach the imager (not shown).

To reduce certain optical aberrations such as field curvature, movable lens L44 is preferably aligned in the z direction so as to set optimum spacing between lenses L43 and L44. Once movable lens L44 is aligned in the desired position, epoxy 713 is used to fix it in position. In some embodiments, epoxy 713 can be replaced by material that is melted by a laser, hot air gun, or other local heating device. In some embodiments, epoxy 713 can be replaced by local melting of the lens barrel 171 so that the melted material comes into contact with L44.

Alternatively, additional lenses and baffles may be included in the lens assembly to achieve the desired optical performance, and less than four lenses and four baffles may be used to reduce cost. Nothing in this specification should be interpreted to limit the scope of the technology disclosed herein to lens assemblies having a set number of lens and/or baffles.

With respect to FIG. 7, movement of the lens L41 in the x and y directions strongly affects image plane tilt and astigmatism, while movement of lens L44 in the z direction strongly affects field curvature. To determine which lenses to actively align and in what direction, a sensitivity analysis can be done on the specific optical design to determine which lenses have large contribution on the aberration that needs to be corrected. More generally, specific optical aberrations can be induced or corrected by adjusting the positions of lenses L41 and L44 to obtain a desired optical performance of the lens assembly.

FIG. 8 shows a cross-sectional view of a lens assembly 180 in accordance with various embodiments of the technology disclosed herein. The lens assembly 180 is comprised of four lenses L51, L52, L53, and L54 and three baffles 183, 185, and 187 inserted in a lens barrel 181. The baffles are interspersed between the lenses as shown. Lenses L51, L52, L53, and L54 are made of conventional lens material such as glass, plastic, optical crystal, or the like. Baffles 183, 185, and 187 are made of conventional baffle material such as plastic, cloth, paper, or the like. Lens barrel 181 is made of conventional lens barrel material such as plastic, metal, or the like.

Lens L52 is positioned inside lens barrel 181 in contact with an inner edge 803 and inside surface 804 of lens barrel 121. Lens L53 is adjacent to, and separated by baffle 185 from, lens L52 and is also in contact with inside surface 804. Lens L54 is adjacent to, and separated by baffle 187 from, lens L53 and is also in contact with inside surface 804. The stack of optical elements is fixed inside the lens barrel by epoxy 809 that connects lens L54 with lens barrel 1221. Baffle 182 defines an aperture which serves as the entrance pupil for the imaging system. Baffle 182 is optionally attached to the front of lens L51 using epoxy 810 and/or attached to lens barrel 181 using epoxy 811.

As a result, lenses L52, L53, and L54 are passively aligned in the lens assembly through physical contact among the lenses L52, L53, L54, the baffles, and lens barrel 181. Alternatively, lenses L52, L53, and L54 could be aligned merely by connections between them. Depending on the method used and the dimensional tolerance of the lenses and lens barrel, the resulting optical alignment precision between lenses may be between less than 1 micron to over 15 microns in the x, y, and z directions.

Movable lens L51 is positioned in front of lens L52. Baffle 183 separates lenses L51 and L52. Movable lens L51 is not precisely positioned by lens barrel 181 and there is a gap 801 that allows movable lens L51 to be moved in the z direction and a radial gap 802 that allows it to be moved in the x and y directions. The gap 802 allows between 5 microns and 50 microns of movement by lens L51 in the x and y directions, and preferably between 5 and 25 microns. The position of lens L51 is preferably fixed with respect to lens barrel 181 by the combination of baffle 182, epoxy 810, and epoxy 811. Gaps 801 and 802 may be optionally omitted.

To reduce certain optical aberrations such as astigmatism, the movable lens L51 may be aligned in the x and y directions so that its optical axis substantially coincides with the optical axis O of the lens assembly 180. This may be done by monitoring the through focus MTF of the lens assembly while the position of the movable lens L51 is adjusted. Other conventional optical measurements of the lens assembly may be used for guiding the adjustment of the position of movable lens L51, including but not limited to, point spread function, line spread function, sharpness, contrast, brightness, spatial frequency response (SFR), subjective quality factor (SQF), and wave front measurements.

Misalignment of lenses L52, L53, and L54 and imperfections in the lenses themselves will typically cause the optical axis O of the lens assembly to not coincide exactly with the optical axis of lens L52. An idealized optical axis O of the lens assembly is shown in FIG. 8. Adjusting the alignment of lens L51 may be used to compensate, in whole or part, for such misalignment and imperfections or, alternatively, create desired optical effects.

Alternatively, since movement of lens L51 in the x and y directions also affects image plane tilt, the position of lens L51 may be adjusted so as to align the optical axis O with the perpendicular of the imager (not shown) so that the entire image is in better focus. This may be done during manufacturing of the lens assembly or after the lens assembly is mounted in the camera.

In a further alternate embodiment, once the movable lens L51 is aligned in the desired position, epoxy (not shown) between lens L51 and inner surface 804 is used to fix it in position. In some embodiments, epoxy (not shown) can be replaced by material that is melted by a laser, hot air gun, or other local heating device. In some embodiments, epoxy (not shown) can be replaced by local melting of the lens barrel 181 so that the melted material comes into contact with L51. As shown in FIG. 8, in various embodiments lens L51 has a flat surface L51A and lens L52 has a flat surface L52A, and both surfaces L51A and L52A are in contact with baffle 183. In an alternate embodiment, baffles 183, 185, and 187 are omitted allowing the lenses to contact each other directly at one or more interfaces. The baffles and interfaces between lenses are preferably designed to avoid allowing stray light to reach the imager (not shown).

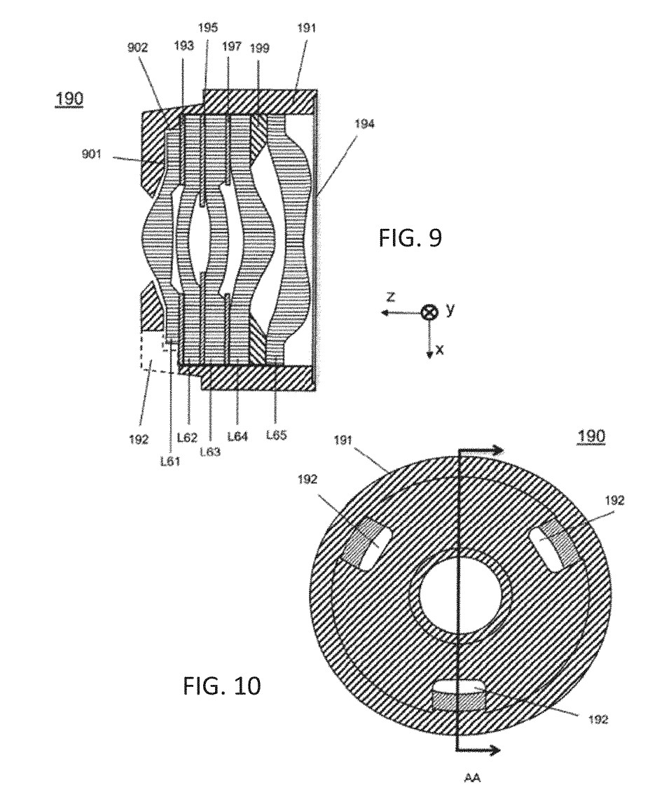

FIG. 9 shows a cross-sectional view of a lens assembly in accordance with various embodiments of the technology disclosed herein. The lens assembly 190 is comprised of five lenses L61, L62, L63, L64, and L65; three baffles 193, 195, and 197; lens spacer 199; and IRCF 194 inserted in a lens barrel 191. The baffles and the lens spacer are interspersed between the lenses as shown. Lenses L61, L62, L63, L64, and L65 are made of conventional lens material such as glass, plastic, optical crystal or the like. Baffles 193, 195, 197 are made of conventional baffle material such as plastic, cloth, paper, or the like. Lens barrel 191 is made of conventional lens barrel material such as plastic, metal, or the like. IRCF 194 is made of glass with an IR coating, plastic, or other conventional material. Lens spacer 199 is made of plastic, rubber, metal, or the like.

Movable lens L61 is not precisely positioned by lens barrel 191 and there is a gap 901 that allows lens L61 to be moved in the z direction and a radial gap 902 that allows it to be moved in the x and y directions. The gap 902 allows between 5 microns and 50 microns of movement by the lens L61 in the x and y directions, and preferably between 5 and 25 microns. Gap 901 may optionally be omitted.

The front surface of lens barrel 191 includes preferably three openings 192 which permit access to movable lens L61 for performing active alignment of lens L61 with the stack of lenses L62, L63, L64, and L65 or for fixing the position of lens L61 in a desired position. Lens L61 is moved via the holes 192 into the designed alignment position and epoxy is inserted through holes 192 to fix lens L61 in the desired position. In some embodiments, epoxy can be replaced by material that is melted by a laser, hot air gun, or other local heating device. In some embodiments, epoxy can be replaced by local melting of the lens barrel 191 so that the melted material comes into contact with L51. The locations for the local melting of the lens barrel 191 may or may not coincide with the location of the holes 192.

FIG. 10 is a top view of the lens assembly 190 discussed with respect to FIG. 9. For clarity, FIG. 9 is a cross-sectional view of lens assembly 190 taken across Line AA of FIG. 10.

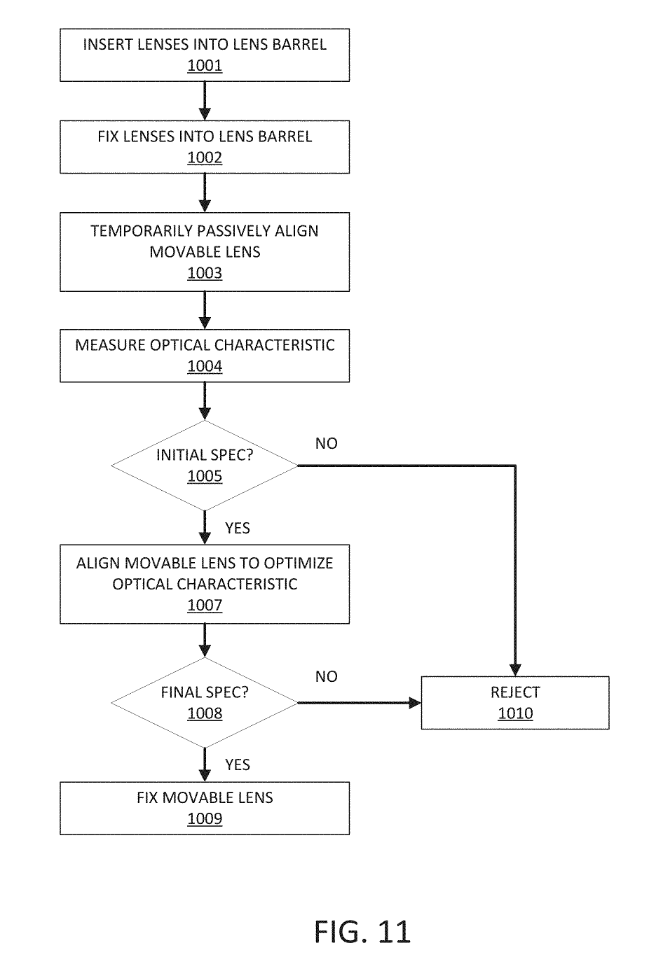

FIG. 11 is a flowchart for an example method of making a lens assembly in accordance with an embodiment of the present invention. At 1001, a lens barrel is provided and a plurality of lenses, including at least one movable lens, and other optical elements are inserted in the lens barrel. The lenses that are not movable are aligned with each other or in a fixed position relative to the lens barrel.

At 1002, at least one of the passively aligned lenses are fixed in position to prevent motion during latter steps. The securing at 1002 is optionally omitted, for example, if the passively aligned lenses are not able to move due to a tight fit with the lens barrel or are held in position by an additional component such as a retainer ring, IRCF window, lens, epoxy, or other optical or mechanical structure of the like.

At 1003, the movable lens is passively aligned temporarily. This may be done using a passive alignment ring as previously described in reference to FIG. 4, or with a fixture that comes down on the lens assembly to align the movable lens with respect to the rest of the lens assembly. This passive alignment of the movable lens may optionally be omitted.

At 1004, at least one optical characteristic of the lens assembly is measured. For example, a MTF measurement may be performed by shining light through a mask that is placed at the image plane of the lens assembly and monitoring the projected image with cameras placed at various field locations, e.g., at center and the four corners at 80% field. Alternatively, a through focus MTF measurement may be performed by making multiple MTF measurements at different field positions while changing the spacing between the lens assembly and the mask. Other measurements of the imaging quality of the lens assembly may be used, including but not limited to, point spread function, line spread function, sharpness, contrast, brightness, spatial frequency response (SFR), subjective quality factor (SQF), and wave front measurement.

At 1005, the measured optical characteristic of the lens assembly is compared with an initial specification for pass/fail detection. If the part fails, it is rejected in step 1010. If the part passes, it moves on to active alignment. This initial specification may not be as stringent as the final requirements for the lens assembly, but should determine that the optical elements in the lens assembly are of sufficient quality to warrant the effort of active alignment. For example, when using a through focus MTF measurement, different field positions may reach peak MTF at different positions of the mask with respect to the lens assembly, such as is the case of image plane tilt or field curvature. Furthermore, the tangential and sagittal MTF curves at a given field position may not be aligned, such as is the case astigmatism.

Using programs such as Zeemax or Code V, one skilled in the art can determine the effect that movement of the movable lens within the range allowable in the lens assembly can have on the through focus MTF curves. For example, in a lens assembly where movement of the first lens in the x and y directions (orthogonal to the optical axis) significantly affects astigmatism and image plane tilt, but does not significantly affect field curvature or the peak MTF for any through focus MTF curve, the initial specification may be to have a minimum requirement for peak MTF for each curve, regardless of misalignment, since adjustments of the movable lens in active alignment will not be able to substantially increase the peak MTF for each through focus curve. The initial specification may also include a minimum requirement for field curvature, since adjustments of the movable lens in active alignment will not be able to substantially reduce field curvature.

At 1007, the active alignment of the movable lens is performed. In various embodiments, the movable lens is held with, for example, a first gripper, and the rest of the lens assembly is held with, for example, a second gripper. The first gripper position is modified with respect to the second gripper position to adjust the position of the movable lens in the lens assembly while the imaging quality is monitored. Once a desired or optimum position for the movable lens is found, the optical characteristic of the lens assembly is compared with a final specification. If the optical characteristic does not meet the final specification, the lens assembly is rejected at 1010. If the characteristic of the lens assembly meets the final specification, the movable lens is fixed in position at 1009 using, for example but not limited to, an epoxy that hardens when exposed to UV light, pressure sensitive adhesive, laser welding, or localized melting.

In various embodiments, a simplified version of the example method discussed with respect to FIG. 11 may be performed by omitting 1002, 1003, 1004, and 1005. In other words, after inserted optical elements into a lens barrel at 1001 the method moves to 1007, where active alignment of the movable lens is performed. Omission of 1002, 1003, 1004, and 1005 may be acceptable in the event that, for example, the performance of the lens assembly is known to be of sufficient quality by employing other quality control processes.

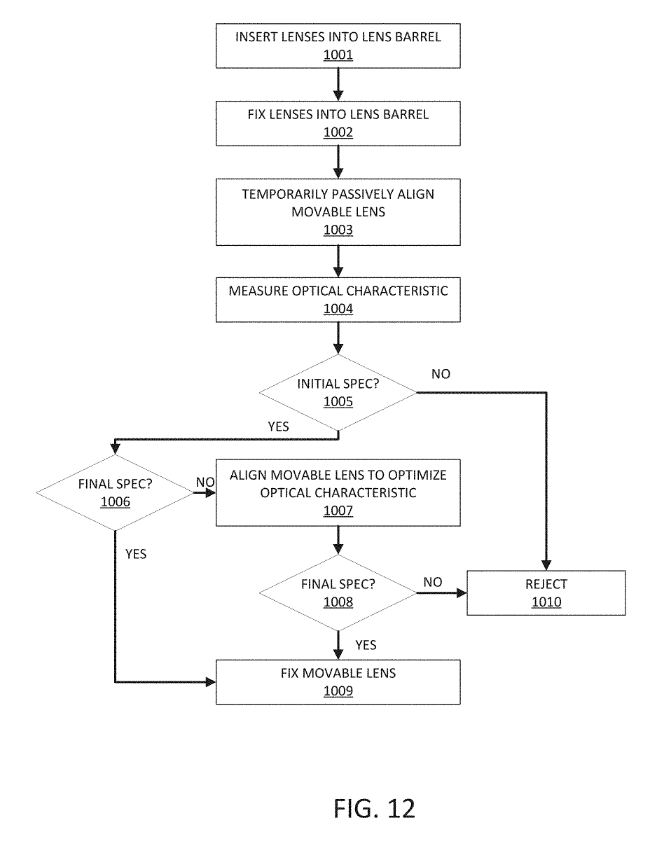

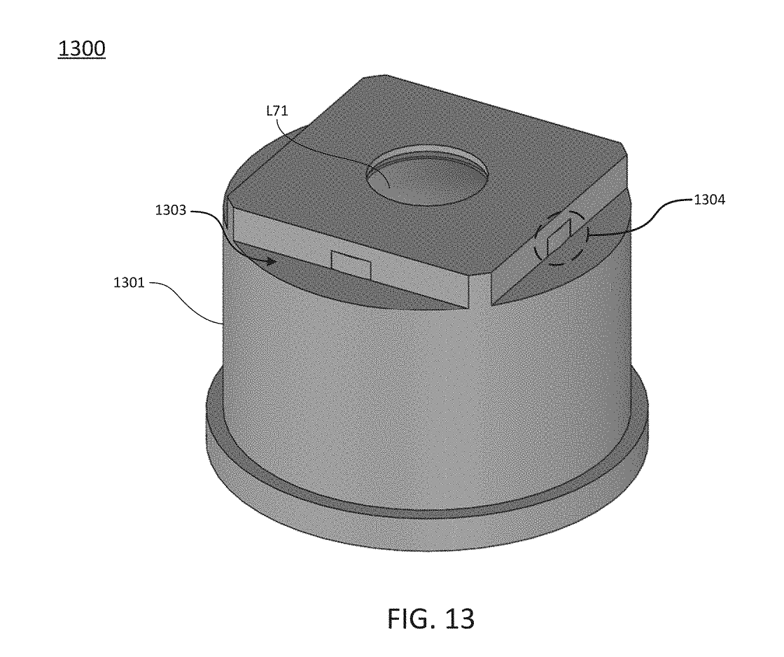

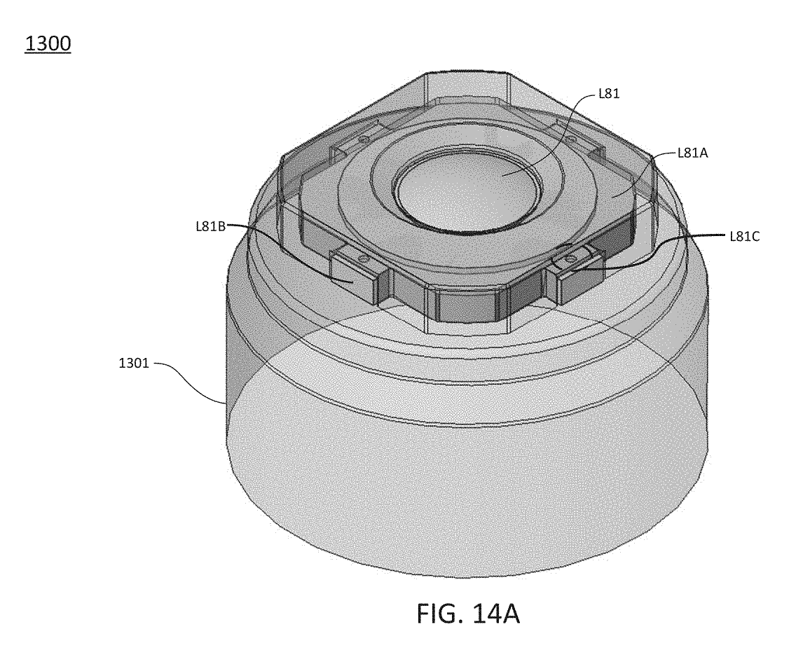

FIG. 12 is a flowchart for another example method of making a lens assembly in accordance with various embodiments of the technology disclosed herein. The example method of FIG. 12 is similar to the example method discussed with respect to FIG. 11, and similarly numbered elements should be interpreted in a similar manner as those discussed with respect to FIG. 11.

At 1006, the optical characteristic of the lens assembly is compared with the final specification to determine if active alignment at 1007 is even needed. If the optical characteristic, such as imaging quality, of the lens assembly measured at 1004 meets the final specification at 1006, the method may skip 1007 and 1008 and the movable lens position is fixed at 1009. Alternatively, if the position of the movable lens has already been temporarily fixed, for example with the passive alignment ring 321 previously described in reference to FIG. 4, the lens assembly may be secured in place using, for example but not limited to, epoxy, adhesive, laser welding, or localized melting.

FIG. 13 illustrates a perspective view of an example lens assembly 1300 in accordance with various embodiments of the technology disclosed herein. The example lens assembly 1300 may have features similar to that of lens assembly 190 discussed with respect to FIG. 10. As illustrated in FIG. 13, the lens assembly 1300 includes a lens barrel 1301, similar to the lens barrels discussed above with respect to FIGS. 2-10. The lens barrel 1301 of lens assembly 1300 encapsulates the lenses, including movable lens L71. In various embodiments, surfaces 1303 (which in some embodiments may be substantially flat or planar) are carved, etched, molded, or otherwise included in the lens barrel 1301. The flat surfaces 1303 provide clearance for grippers to interface with the lens barrel 1301 for active alignment of the lens L71. In various embodiments, openings or holes 1304 through which one or more portions of lens L71 (in this case edges of lens L71) can protrude are included, providing access to the movable lens L71 for active alignment. The holes 1304 are similar to the holes 192 discussed above with respect to FIG. 10. During active alignment, a gripper interfaces with the movable lens L71 through the holes 1304 to move the lens L71 to achieve the proper or desired optical characteristic.

Although the top of the lens barrel 1301 is illustrated as being square-like in shape, the flat surfaces 1303 may be designed such that the top of lens barrel 1301 may be another shape, for example but not limited to, a triangle, hexagon, circle, or others. The number of flat surfaces 1303 may vary depending on the desired shape or the manufacturing tools (e.g., grippers) utilized in manufacturing the lens assembly 1300. In various embodiments, the number of holes 1304 may be equivalent to the number of flat surfaces 1303 included. In other embodiments, fewer holes 1304 may be included with respect to the number of flat surfaces 1303. Still other embodiments may have more holes 1304 with respect to the number of flat surfaces 1303. A person of ordinary skill would appreciate that the total number of holes 1304 and flat surfaces 1303 is dependent on the particular implementation, and that the scope of this disclosure is not limited to any set number and/or shape-defined. Although not shown in FIG. 13, one or more gaps may be included to allow access to other lenses besides L71 whether or not they are movable in the x, y, and/or z directions (depending on the design of the lens assembly 1300).

As discussed above, the lenses in the lens assembly need to be secured or fixed in place to ensure the proper or desired optical characteristics. Traditionally, epoxy is the predominant method of securing lenses into place after alignment. Epoxy, however, increases the manufacturing time for lens assemblies. The epoxy must be given time to cure and harden after application so that the lenses or other optical elements maintain their relative position. Curing adds time to the manufacturing process, reducing yield as the lens assembly must be kept stationary to avoid movement of one or more lenses before the epoxy sets. Despite the additional curing time, some lens assemblies may still fail to meet required tolerances.

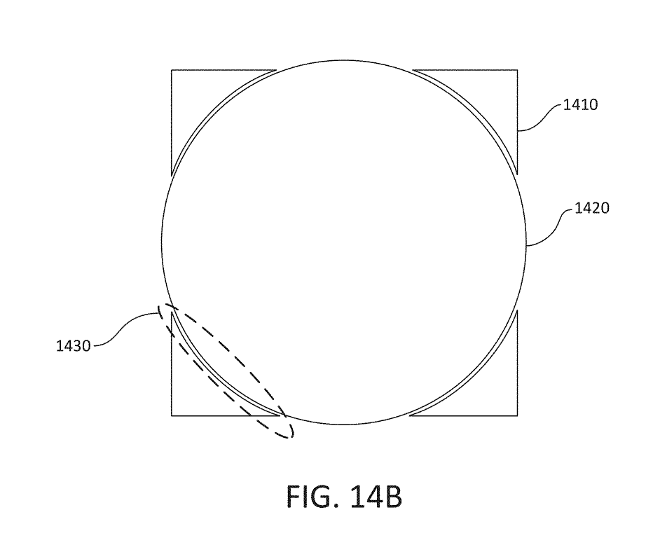

To decrease the time of manufacture and to reduce the potential for errors introduced through the use of epoxies, some embodiments may utilize localized melting to secure lenses in place. FIG. 14A illustrates an example movable lens L81 with features designed to take advantage of localized melting in accordance with various embodiments of the technology disclosed herein. Example movable lens L81 is illustrated in lens assembly 1300 for ease of discussion. Although shown in a particular lens assembly, nothing in this disclosure should be interpreted as limiting the use of movable lens L81 (or its embodiments) to a particular lens barrel design. A person of ordinary skill in the art would appreciate that the shape of lens L81 could be modified to work within any lens barrel.

As illustrated in FIG. 14A, the movable lens L81 is within the lens barrel 1301. In order to show and discuss the features of lens L81, lens barrel 1301 is illustrated as being transparent. In various embodiments, the lens barrel 1301 is opaque to prevent stray light from entering the imaging system outside of the intended path through the entrance (e.g., pupil). In various embodiments, lens L81 made be made of conventional lens material such as glass, plastic, optical crystal, or the like. Lens barrel 1301 may be made of conventional lens barrel material, such as plastic, metal, or the like. Although not shown, additional optical elements (e.g., other lenses, baffles, etc.) may be included within the lens barrel 1301 (similar to previously discussed embodiments).

The movable lens L81 may have a non-imaging portion L81A such that the optical portion of the movable lens L81 is not directly contacted during alignment. The shape of the non-imaging portion L81A may be designed to allow for uniform thickness of the lens barrel 1301 around at least one some portions of the movable lens L81. This may allow for simplified manufacturing processes. In the illustrated example, the portion of the lens barrel 1301 surrounding the movable lens L81 is square-shaped, and the non-imaging portion L81A is configured to match the shape of the portion of the lens barrel 1301 (i.e., the general shape of non-imaging portion L81A is a square with the corners cut off). In areas where the lens barrel and movable lens L81 are not uniformly designed, the thickness of the lens barrel can vary between holes included for active alignment. For example, FIG. 14B illustrates the arrangement in a traditional lens assembly enabling active alignment. As illustrated, a circular lens 1420 is inserted inside a lens barrel 1410 with a square shape. A portion of the lens is free for active alignment through openings in the lens barrel, similar to the holes 1304 discussed above with respect to FIGS. 13 and 14A. To ensure that the lens is not capable of moving around too much during active alignment, the gap 1430 between the lens 1420 and the lens barrel 1410 must have small tolerances, meaning that it must substantially match the shape of the lens 1420, at least in some locations. Therefore, when the lens barrel 1410 itself is not circular in shape around the lens 1420, the thickness of the material of the lens barrel 1410 will vary along the arc of the lens 1420. This impacts manufacturing of the lens barrel, as well as the structural integrity of the points of the lens barrel at the openings.

Referring to FIG. 14A, the movable lens L81 further includes several alignment tabs L81B, each of which may extend through each of holes 1304. The alignment tabs L81B enable active alignment of the movable lens L81, e.g., one of the aforementioned grippers grasps or pushes movable lens L81 by way of one or more of alignment tabs L81B. In various embodiments, the alignment tabs L81B include a depression L81C. The depression L81C may be a hole extending partially into the alignment tab L81B in some embodiments. The depression L81C serves as an interface to enable melted material to flow into the depression L81C to secure the movable lens L81 in a desired position once aligned. Localized melting may be used to melt material such that it flows using, for example but not limited to, focused lasers, heat guns, or other methods of providing heat to a local area. In some embodiments, the lens barrel 1301 may include a melt region above or proximate to the alignment tabs L81B. Localized melting may be used to melt the melt region of the lens barrel 1301 above or proximate to the depression L81C on each alignment tab L81B. As the lens barrel is melted, the material from the melt region will flow into the depression L81C on each alignment tab L81B. Once heat is removed, the material will cool, fusing the lens barrel 1301 and the movable lens L81 together. In this way, the movable lens L81 is secured in position following alignment, without the need for epoxy and its extended curing time. This eliminates the need for any additional material (e.g., epoxy, adhesive, etc.).

As described above, the depression L81C serves as an interface for the melted material and the movable lens L81. How depression L81C is configured may vary. In various embodiments, the depression L81C may extend the entire height of the alignment tab L81B, such that the melted material can flow completely through the alignment tab L81B and contact an interior edge of the lens barrel 1301, a baffle placed beneath the movable lens L81, another lens below the movable lens L81, or other structure. In other embodiments, multiple depressions L81C may be included on each alignment tab L81B. In various embodiments, the lens barrel 1301 may include a melt region associated with each depression L81C, or a single melt region may correspond to several depressions L81C within a given area. The depression L81C may vary in shape as well in other embodiments. Non-limiting shapes and configurations of the depression L81C include: circular; rectangular slot; holes with a pitch (i.e., not perfectly orthogonal to the surface of the alignment tab L81B, but included on an angle); among others. In various embodiments, the depression L81C may be included on the non-imaging portion L81A of the movable lens L81 in addition to (or in the alternative to) inclusion on the alignment tabs L81B. In some embodiments, movable lens L81 may utilize some form of protrusion about which melted material can flow thereby locking movable lens L81 in place. In other embodiments, a combination of depressions and/or protrusions may be utilized.

In some embodiments, the alignment tabs L81B may include a ledge cut into it as another interface with the lens barrel 1301 after melting. The ledge may be located on the top of the alignment tab L81B. In some embodiments, the ledge may serve as a stop to limit the motion of the movable lens L81 by being designed to contact the lens barrel 1301 when the movable lens L81 has reached its maximum displacement within the lens barrel 1301. In addition to the melted material from the melt region of the lens barrel 1301 flowing into the depression L81C, melted material may also flow over the ledge of the alignment tab L81B to secure the movable lens L81 in place. In some embodiments, the depression L81C may be omitted, and the securing of the lens may be accomplished through interaction of the ledge with the melted material.

In various embodiments, the alignment tabs L81B may include an interface, extending out from the hole 1304 and resting on top of the lens barrel 1301 and/or support structure upon which the movable lens L81 rests. After alignment, material may be melted to flow over the interface, thereby securing the movable lens in place. In this way, the localized melting can be extended away from the optical portion of the movable lens L81, reducing the potential for material to flow and interfere with the optical performance of the lens assembly.

Although discussed with respect to features included on the movable lens L81, features not included in the movable lens L81 may also be used to secure the lens in place. In various embodiments, the movable lens L81 may rest atop an edge of the lens barrel 1301 extending inwards. The edge of the lens barrel 1301 may have a surface with which the movable lens L81 is in contact. The surface may be rough or have features present designed to interface with the melted material. During localized melting, the melted material may flow into and fill the areas of the rough surface or to interface with the features present on the surface, fusing the movable lens L81 to the lens barrel. In some embodiments, the melted material may flow through depressions L81C to the surface of the edge of the lens barrel 1301, while in other embodiments the melted material may flow over the ledge of the alignment tabs L81B and onto the surface. In some embodiments, the lens barrel may be melted such that the melted material flows into the gaps between the movable lens L81 and the lens barrel 1301. By essentially collapsing the lens barrel 1301, the gaps are removed and the lens L81 and lens barrel 1301 may be fused together such that there is no room for the movable lens L81 to move.

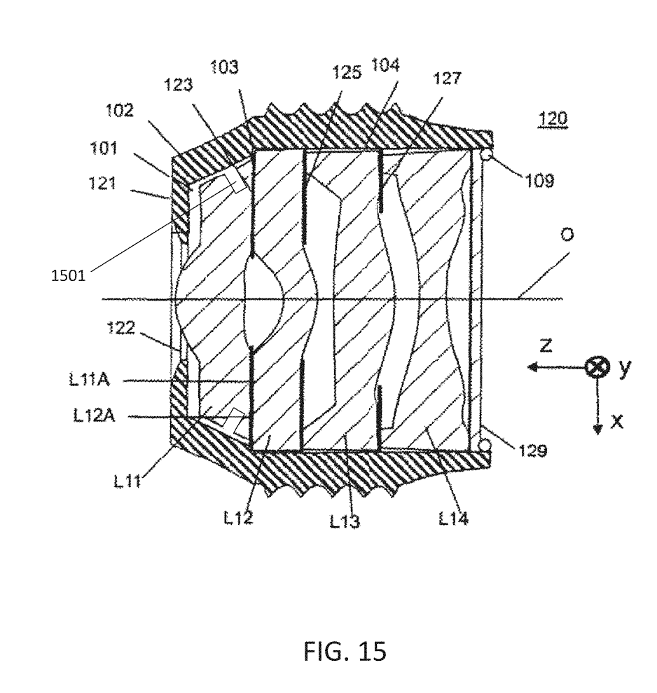

Although discussed with respect to a movable lens having specific features and shapes, the localized melting method of securing a lens may be applied to other movable lenses as well. For example, FIG. 15 illustrates a modified version of the lens assembly 120 discussed with respect to FIG. 2. As illustrated in FIG. 15, the epoxy (reference 111) utilized in FIG. 2 is not present, and a depression 1501 is included in the movable lens L11. In some cases, the depression 1501 may be a trough extending the entire circumference of the movable lens L11. In other embodiments, the depression 1501 may be discrete depressions included in the movable lens L11, similar to the depressions L81C discussed with respect to FIG. 14A. After alignment, localized melting may be applied to the lens barrel 121 around the areas of the depression 1501, with the melted material flowing into the depression 1501. In this way, the movable lens L11 may be secured in place and fused to the lens barrel 121 without the need for epoxy.

Although discussed with respect to embodiments wherein the lens barrel encapsulates the movable lens, the localized melting techniques described herein may be applied to other types of lens assemblies. For example, with respect to embodiments disclosed in FIG. 3, the localized melting may be applied to the baffle 132 (with a melt region similar to the melt region discussed above with respect to lens barrel 1301) and configured such that the melted material flows into a depression on the lens L21 and/or into the space between the lens L21 and the lens barrel 131. For another example, a laser may be used to melt the baffle 153 resting between the lenses L31 and L32 in the lens assembly discussed with respect to FIG. 5. The melted baffle 153, when cooled, would fuse the movable lens L31 to the passively aligned lens L32 (which is already secured within the lens barrel 151). In this way, the movable lens L31 will be secured in place through its fusion with lens L32 by the melted material of baffle 153.

Similar methods of localized melting may be used to secure internal optical elements of the lens assembly as well. In some embodiments, localized melting may be used to ensure that passively aligned lenses are secured within the lens barrel. For example, lens L33 of the lens assembly discussed with respect to FIG. 5 may include one or more features designed to interface with melted material. By applying a heat source locally to the side of the lens barrel 151 near the features, lens barrel material may flow into the features to secure lens L33 in place. This localized melting method may be used to secure any and all optical elements within a lens assembly, depending on the needs of the design.

In various embodiments, the localized melting may be applied to a melt region of the non-imaging portion of a movable lens such that the melted material is from the lens, as opposed to the lens barrel or some other optical element. For example, in some embodiments a depression, similar to the depression discussed with respect to FIG. 14A, may be included on the lens barrel surface upon which the movable lens L81 rests. When heat is applied locally to the melt region of the non-imaging portion L81A, the melted material can flow into the depression included on the surface of the lens barrel 1301 underneath the movable lens L81, resulting in a similar fusing of the movable lens L81 and the lens barrel 1301. It should be noted that although embodiments disclosed herein are described as having some form of mating element(s), the fusing or fixing of a movable lens to a lens barrel, a lens barrel to a movable lens, a movable lens to a baffle, etc., the respective materials may have properties allowing such fusing or fixing without such mating elements.

Where the lens barrel encapsulates the movable lens (as shown in FIG. 14A, the lens barrel 1301 may be made of a material with a higher melting point than the non-imaging portion L81A of the movable lens L81, such that the lens barrel will not melt during the localized melting. In various embodiments, the lens barrel 1301 and the movable lens L81 may comprise materials with different melting points, depending on the particular application. In various embodiments, the lens barrel 1301 may itself comprise different materials, each with different melting points, to indicate where localized melting can occur and to reduce the possibility of melting occurring in non-optimal areas. In various embodiments, the movable lens L81 may comprise more than one type of material, each having different melting points. For example, the imaging portion of the movable lens L81 may be made of glass, while the non-imaging portion L81A is made of plastic with a lower melting point than glass. In this way, the non-imaging portion of L81A may be melted without impacting the imaging portion of the movable lens L81.

The localized melting discussed above may be utilized at 1009 of the example methods discussed with respect to FIGS. 11 and 12.

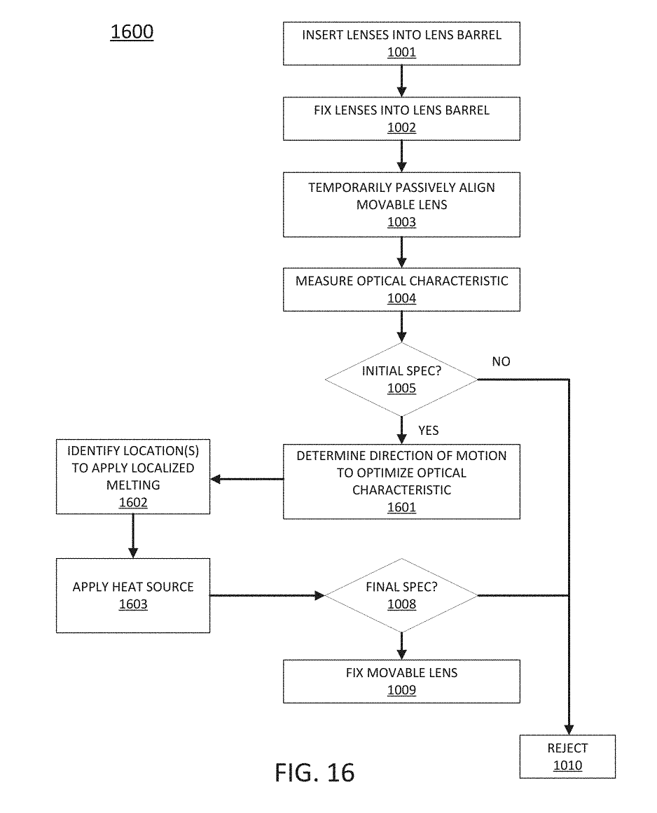

In addition to securing optical elements in place, localized melting may be utilized to conduct the active alignment of the movable lens or lenses, eliminating the need to physically grip the lens. FIG. 16 is a flow chart of an example active alignment method 1600 in accordance with various embodiments of the technology discussed herein. Elements with the same reference numerals as those discussed with respect to FIG. 11 should be interpreted in the same manner. This method may be used in embodiments irrespective of the use of localized melting to secure optical elements in place. In other words, this method of active alignment may be used with traditional lens assemblies as well as those designed to take advantage of localized melting for securing lenses.

As illustrated in FIG. 16, the active alignment method 1600 is similar to the method discussed with respect to FIG. 11 until the result of the initial specification check at 1005. If the lens assembly passes that initial specification, the direction of motion of the movable lens necessary to optimize the optical characteristic is determined at 1601. As discussed above, using programs such as Zeemax or Code V, one skilled in the art can determine the effect that movement of the movable lens within the range allowable in the lens assembly can have on the through focus MTF curves. For example, in a lens assembly where movement of the first lens in the x and y directions (orthogonal to the optical axis) significantly affects astigmatism and image plane tilt, but does not significantly affect field curvature or the peak MTF for any through focus MTF curve, the initial specification may be to have a minimum requirement for peak MTF for each curve, regardless of misalignment, since adjustments of the movable lens in active alignment will not be able to substantially increase the peak MTF for each through focus curve. The initial specification may also include a minimum requirement for field curvature, since adjustments of the movable lens in active alignment will not be able to substantially reduce field curvature.

At 1602, locations where localized melting is to occur to achieve the determined motion are identified. The locations where localized melting is to occur may be dependent on the particular shape of the movable lens implemented. For example, where the movable lens is circular, more points along a particular arc may be necessary to ensure motion in the proper direction as opposed to a square lens.

At 1603, the heat source is applied to the identified locations. Non-limiting examples of heat sources include: focused lasers; heat guns; or other methods of providing heat to a local area. After melting, the lens assembly is inspected to determine if it meets the final specification at 1008, as discussed with respect to FIG. 11. The method then proceeds similar to the method discussed with respect to FIG. 11. At 1009, fixing the lens may include the traditional methods (e.g., epoxy) or the localized melting method discussed above with respect to FIGS. 13-15.

The determinations at 1601, 1602, and 1603 may, in some embodiments, be automated by a computer-assisted manufacturing tool. The identification of locations and control of how long to apply localized heat can be automated.

In various embodiments, a simplified version of the example method discussed with respect to FIG. 16 may be performed by omitting 1002, 1003, 1004, and 1005. In other words, after inserting optical elements into a lens barrel at 1001 the method moves to 1007, where active alignment of the movable lens is performed. Omission of 1002, 1003, 1004, and 1005 may be acceptable in the event that, for example, the performance of the lens assembly is known to be of sufficient quality by employing other quality control processes.

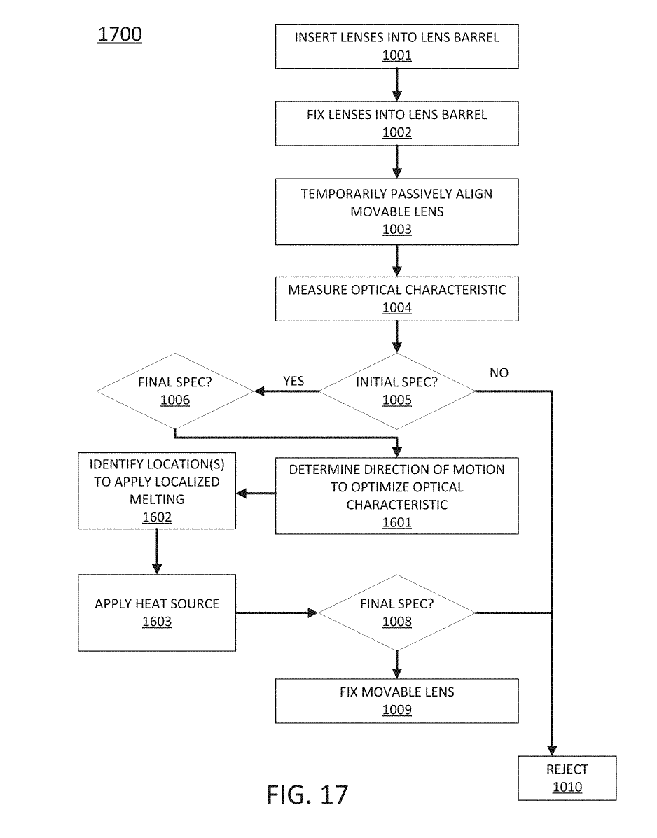

FIG. 17 is a flowchart for another example method of making a lens assembly in accordance with various embodiments of the technology disclosed herein. The example method of FIG. 17 is similar to the example method discussed with respect to FIGS. 11, 12, and 16, and similarly numbered elements should be interpreted in a similar manner as those discussed with respect to FIGS. 11, 12, and 16.

As used herein, the term set may refer to any collection of elements, whether finite or infinite. The term subset may refer to any collection of elements, wherein the elements are taken from a parent set; a subset may be the entire parent set. The term proper subset refers to a subset containing fewer elements than the parent set. The term sequence may refer to an ordered set or subset. The terms less than, less than or equal to, greater than, and greater than or equal to, may be used herein to describe the relations between various objects or members of ordered sets or sequences; these terms will be understood to refer to any appropriate ordering relation applicable to the objects being ordered.

The term tool can be used to refer to any apparatus configured to perform a recited function. For example, tools can include a collection of one or more modules and can also be comprised of hardware, software or a combination thereof. Thus, for example, a tool can be a collection of one or more software modules, hardware modules, software/hardware modules or any combination or permutation thereof. As another example, a tool can be a computing device or other appliance on which software runs or in which hardware is implemented.

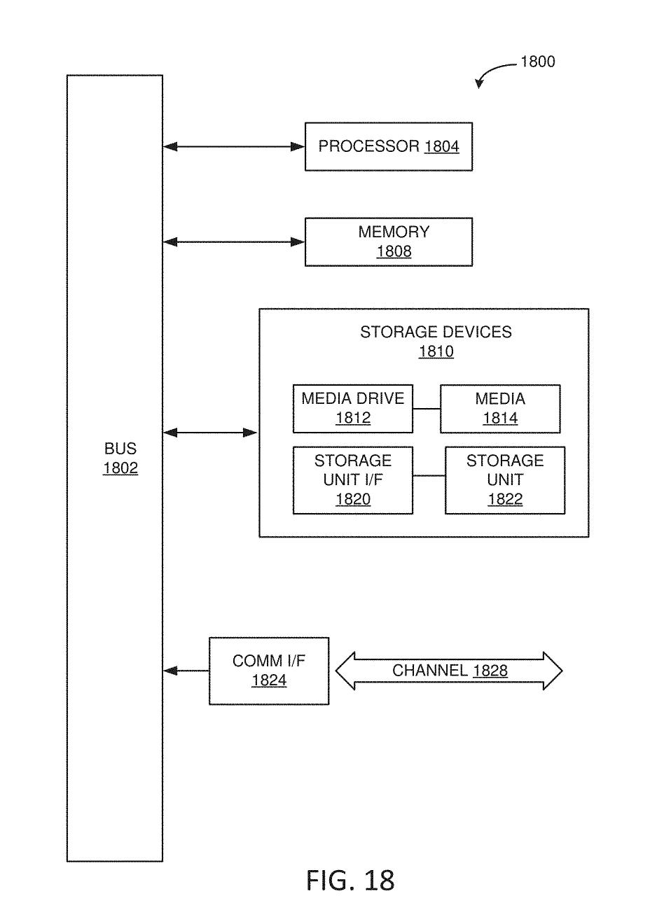

As used herein, the term module might describe a given unit of functionality that can be performed in accordance with one or more embodiments of the technology disclosed herein. As used herein, a module might be implemented utilizing any form of hardware, software, or a combination thereof. For example, one or more processors, controllers, ASICs, PLAs, PALs, CPLDs, FPGAs, logical modules, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software modules are used to implement such features or functionality.

Where modules or modules of the technology are implemented in whole or in part using software, in one embodiment, these software elements can be implemented to operate with a computing or processing module capable of carrying out the functionality described with respect thereto. One such example computing module is shown in FIG. 18. Various embodiments are described in terms of this example-computing module 1800. After reading this description, it will become apparent to a person skilled in the relevant art how to implement the technology using other computing modules or architectures.

Referring now to FIG. 18, computing module 1800 may represent, for example, computing or processing capabilities found within manufacturing machinery such as CNC machines; production belts; manufacturing robots; semiconductor manufacturing equipment; or any other type of special-purpose or general-purpose computing devices as may be desirable or appropriate for a given application or environment.

Computing module 1800 might include, for example, one or more processors, controllers, control modules, or other processing devices, such as a processor 1804. Processor 1804 might be implemented using a general-purpose or special-purpose processing engine such as, for example, a microprocessor, controller, or other control logic. In the illustrated example, processor 1804 is connected to a bus 1802, although any communication medium can be used to facilitate interaction with other modules of computing module 1800 or to communicate externally.

Computing module 1800 might also include one or more memory modules, simply referred to herein as main memory 1808. For example, preferably random access memory (RAM) or other dynamic memory, might be used for storing information and instructions to be executed by processor 1804. Main memory 1808 might also be used for storing temporary variables or other intermediate information during execution of instructions to be executed by processor 1804. Computing module 1800 might likewise include a read only memory (“ROM”) or other static storage device coupled to bus 1802 for storing static information and instructions for processor 1804.

The computing module 1800 might also include one or more various forms of information storage mechanism 1810, which might include, for example, a media drive 1812 and a storage unit interface 1820. The media drive 1812 might include a drive or other mechanism to support fixed or removable storage media 1814. For example, a hard disk drive, a floppy disk drive, a magnetic tape drive, an optical disk drive, a CD or DVD drive (R or RW), or other removable or fixed media drive might be provided. Accordingly, storage media 1814 might include, for example, a hard disk, a floppy disk, magnetic tape, cartridge, optical disk, a CD or DVD, or other fixed or removable medium that is read by, written to or accessed by media drive 1812. As these examples illustrate, the storage media 1814 can include a computer usable storage medium having stored therein computer software or data.

In alternative embodiments, information storage mechanism 1810 might include other similar instrumentalities for allowing computer programs or other instructions or data to be loaded into computing module 1800. Such instrumentalities might include, for example, a fixed or removable storage unit 1822 and an interface 1820. Examples of such storage units 1822 and interfaces 1820 can include a program cartridge and cartridge interface, a removable memory (for example, a flash memory or other removable memory module) and memory slot, a PCMCIA slot and card, and other fixed or removable storage units 1822 and interfaces 1820 that allow software and data to be transferred from the storage unit 1822 to computing module 1800.

Computing module 1800 might also include a communications interface 1824. Communications interface 1824 might be used to allow software and data to be transferred between computing module 1800 and external devices. Examples of communications interface 1824 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1824 might typically be carried on signals, which can be electronic, electromagnetic (which includes optical) or other signals capable of being exchanged by a given communications interface 1824. These signals might be provided to communications interface 1824 via a channel 1828. This channel 1828 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 1808, storage unit 1820, media 1814, and channel 1828. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 1800 to perform features or functions of the disclosed technology as discussed herein.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the modules or functionality described or claimed as part of the module are all configured in a common package. Indeed, any or all of the various modules of a module, whether control logic or other modules, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A lens assembly, comprising:
a first plurality of lenses;
a lens barrel configured to receive and align the first plurality of lenses; and
at least one additional lens fixedly attached to the lens barrel in a desired alignment position with respect to the first plurality of lenses;
wherein the at least one additional lens is attached to the lens barrel via localized melting.

2. The lens assembly of claim 1, wherein at least one area of the lens assembly shows a location of localized melting.

3. The lens assembly of claim 1, wherein localized melting is achieved by strategically heating one or more portions of the lens barrel such that melted material of the lens barrel flows into or around features of the at least one movable lens.

4. The lens assembly of claim 3, wherein the features are configured to interact with the flow of melted material.

5. The lens assembly of claim 1, wherein localized melting is achieved by heating one or more portions of the at least one movable lens such that melted material of the at least one movable lens flows or deforms into or around features of the lens barrel.

6. The lens assembly of claim 5, wherein the features are configured to interact with the flow of melted material.

7. The lens assembly of claim 1, wherein active alignment of the lens barrel and the at least one additional lens is achieved without mechanical grippers.

8. A method, comprising:
determining a direction of motion of at least one lens having at least one degree of freedom of movement with respect to a first plurality of lenses to achieve a desired optical characteristic;
identifying one or more locations around a circumference of the at least one lens to locally apply heat from a heat source;
applying heat to the one or more locations to cause a flow of melted material or deformation of material to move the at least one lens in the determined direction of motion;
determining if the desired optical characteristic is attained; and
if the desired optical characteristic is attained, fixing the at least one lens to a lens barrel.

9. The method of claim 8, wherein applying heat to the one or more locations comprises strategically heating the one or more locations.

10. The method of claim 8, further comprising active aligning the at least one lens and the first plurality of lenses without mechanical grippers.

11. A lens, comprising:
an optical portion substantially aligned with an optical axis of a lens assembly;
a non-imaging portion configured to interact with a side of a lens barrel during active alignment;
one or more alignment tabs radially extending from the non-imaging portion; and
one or more interface features disposed on the one or more alignment tabs.

12. The lens of claim 11, wherein at least one area of the lens assembly shows a location of localized melting.

13. The lens of claim 12, wherein the one or more interface features are configured to interface with a flow of melted material during localized melting.

14. The lens of claim 13, wherein localized melting is achieved by strategically heating one or more portions of the lens barrel such that melted material of the lens barrel flows or deforms into or around the interface features.

15. The lens of claim 14, wherein the interface features are configured to interact with the flow of melted material.

16. The lens of claim 11, wherein active alignment is achieved without mechanical grippers.

17. A lens assembly, comprising:
a lens element comprising a securing element;
a lens barrel adapted to receive the lens element, wherein the lens barrel comprises a melt region, the at least one melt region fastening the lens element to the lens barrel upon the melt region melting, flowing or deforming into or about the securing element, and setting of the melt region.

18. The lens assembly of claim 17, wherein active alignment of the lens barrel and the lens element is achieved without mechanical grippers.
